(19) United States
(12) Patent Application Publication
(10) Pub. No.: US 2005/0236408 A1
(43) Pub. Date: Oct. 27, 2005

(54) Door position sensing system for cooking appliance including combination heating system

(75) Inventor: Robert A. Schulte, Williamsburg, IA (US)

Correspondence Address: DIEDERIKS & WHITELAW, PLC, 12471 Dillingham Square, #301, Woodbridge, VA, 22192, US

(73) Assignee: Maytag Corporation

(21) Appl. No.: 10/991,941

(22) Filed: Nov. 19, 2004

Related U.S. Application Data
(60) Provisional application No. 60/560,278, filed on Apr. 8, 2004.

(51) Int. Cl. H05B 6/68

(52) U.S. Cl. 219/737

(57) ABSTRACT

A cooking appliance includes a heating system having at least a microwave energy source, but which is preferably capable of combining radiant, convection, microwave and conduction heating techniques to perform a cooking operation. A door position sensing system, including multiple sensors, is responsive to a magnetic field developed by a permanent magnet carried by the door of the cooking appliance. In the absence of a predetermined magnetic field impinging upon at least two separate sensors, it is determined that the door is in an open state, whereupon the generation of microwave energy is terminated.

### CROSS-REFERENCE TO RELATED APPLICATION

The present application claims the benefit of U.S. Provisional Patent Application Ser. No. 60/560,278 entitled “Door Position Sensing System for Cooking Appliance Including Combination Heating System” filed Apr. 8, 2004.

### BACKGROUND OF THE INVENTION

1. Field of the Invention

The present invention pertains to the art of cooking appliances and, more particularly, to a system which senses the open/closed state of a door of a compact cooking appliance including at least a microwave heating capability, but which is preferably capable of combining radiant, convection, conduction and microwave heating techniques to perform a cooking operation.

2. Discussion of the Prior Art

There exist a wide range of cooking appliances on the market. Many of these cooking appliances are designed for use in cooking various types of food products in different ways. For instance, where more conventional cooking appliances generally relied upon radiant energy as the sole heat source, more recent trends combine a radiant heat source with convection, microwave or conduction heating techniques, thereby increasing the versatility of the cooking appliance while potentially shortening required cook times. In particular, the prior art contains examples of appliances that combine radiant and convection cooking; convection, microwave and radiant cooking; and microwave, convection and conduction heating techniques.

Regardless of the variety of known cooking appliances, there exists the need for a versatile cooking appliance that can preferably take advantage of radiant, convection, microwave and conduction cooking techniques such that the appliance can be used to rapidly and effectively cook a wide range of food items. Particularly, in connection with at least microwave cooking appliances, there exists a need in assuring that the microwave generator is not permitted to produce microwaves whenever the door of the cooking appliance is open. For this reason, it is common to provide an interlock switch that is associated with a latch for the door wherein, if the door is opened, the switch is opened and power to the microwave generator is terminated. Although the use of an interlock switch is effective, the connection is mechanical in nature which can be prone to fatigue failure. In addition, there is generally no monitoring or back-up system employed in combination with the mechanical interlock. To this end, there still exists a need for an improved system for determining the open/closed state of a microwave cooking appliance door and, more particularly, a non-mechanical door open/closed position sensing system which is both reliable and cost effective.

### SUMMARY OF THE INVENTION

The present invention is directed to a door position sensing system for a cooking appliance including a cooking chamber, having top, bottom, rear and opposing side walls, into which at least microwave energy is introduced to perform a cooking operation. In accordance with the most preferred embodiment of the invention, the cooking appliance actually includes at least one radiant heating element exposed to the cooking chamber, a convection fan, a microwave heating device having at least one rotatable antenna and a conduction heating device, all of which can be operated in combination to perform a cooking operation.

In accordance with the invention, the door position sensing system senses the position of a door, which is adapted to close off the cooking chamber, and terminates the generation of microwave energy when the door is open. More specifically, the position of the door is sensed by means of a magnetic field. In the most preferred embodiment of the invention, a permanent magnet is fastened to the door and cooperates with a sensing circuit arranged in a cabinet of the cooking appliance. The sensing circuit preferably employs three sensing units which individually sense the open/closed position of the door. The individual signals are collectively utilized to assure that the generation of microwave energy is halted whenever the door assumes an open state. Particularly, hall effect devices and/or magnetic reed switches are used to detect the magnetic field of the permanent magnet. The power to the microwave heating device is cut-off in the absence of a predetermined magnetic field impinging on one or more of the sensing units. The third sensing unit is actually part of a solid-state monitor circuit provided for protection purposes.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is an upper right perspective view of a cooking appliance incorporating a combination heating system constructed in accordance with the present invention;

FIG. 2 is a front view of the cooking appliance of FIG. 1 with a cooking chamber of the appliance exposed;

FIG. 3 is an upper right perspective view of the cooking appliance of FIG. 1 with an outer cabinet portion of the appliance removed;

FIG. 4 is a cross-sectional side view of the cooking appliance constructed in accordance with the present invention;

FIG. 5 is a plan view of a top portion of a cooking chamber of the appliance; and

FIG. 6 is schematic block diagram of a control system constructed in accordance with the present invention.

### DETAILED DESCRIPTION OF THE PREFERRED EMBODIMENT

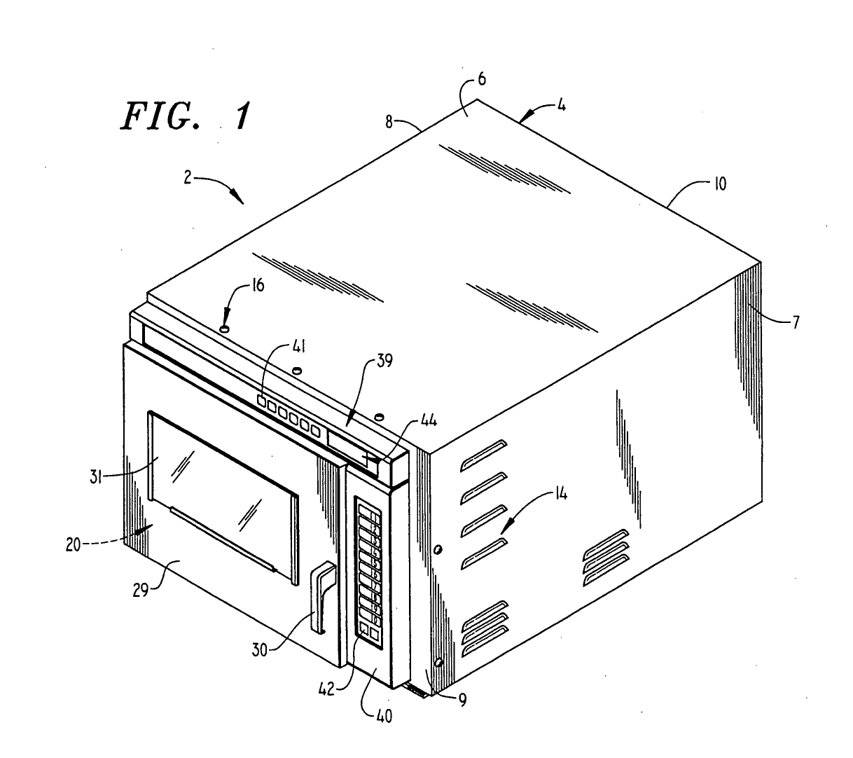

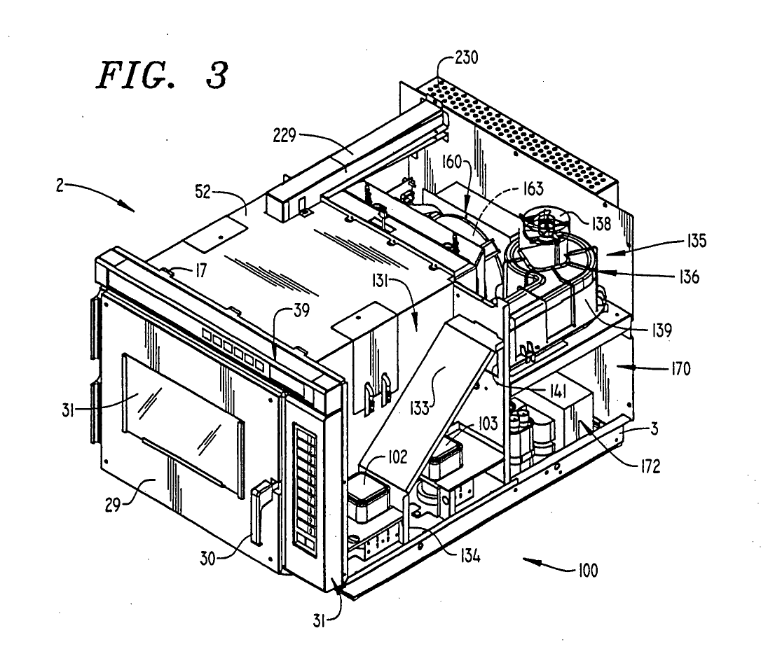

With initial reference to FIGS. 1-3, a cooking appliance constructed in accordance with the present invention is generally indicated at 2. As shown, cooking appliance 2 includes a base frame 3 to which is secured an outer cabinet shell 4 having top and opposing side panels 6-8. Cooking appliance 2 is also provided with a front face or wall 9 and a rear panel 10. Arranged at a lower portion of front wall 9 is an intake air vent 12 through which, as will be discussed more fully below, an ambient air flow enters into cabinet shell 4. In addition, cabinet shell 4 includes a plurality of air discharge vents, indicated generally at 14, arranged on side panel 7. Vents 14 enable cooling air to exit from within cooking appliance 2, thereby removing heat from within cabinet shell 4. Cabinet shell 4 is secured over base frame 3 through a plurality of fasteners 16, with the fasteners 16 arranged along front wall 9 being secured at tabs 17 (see FIG. 3).

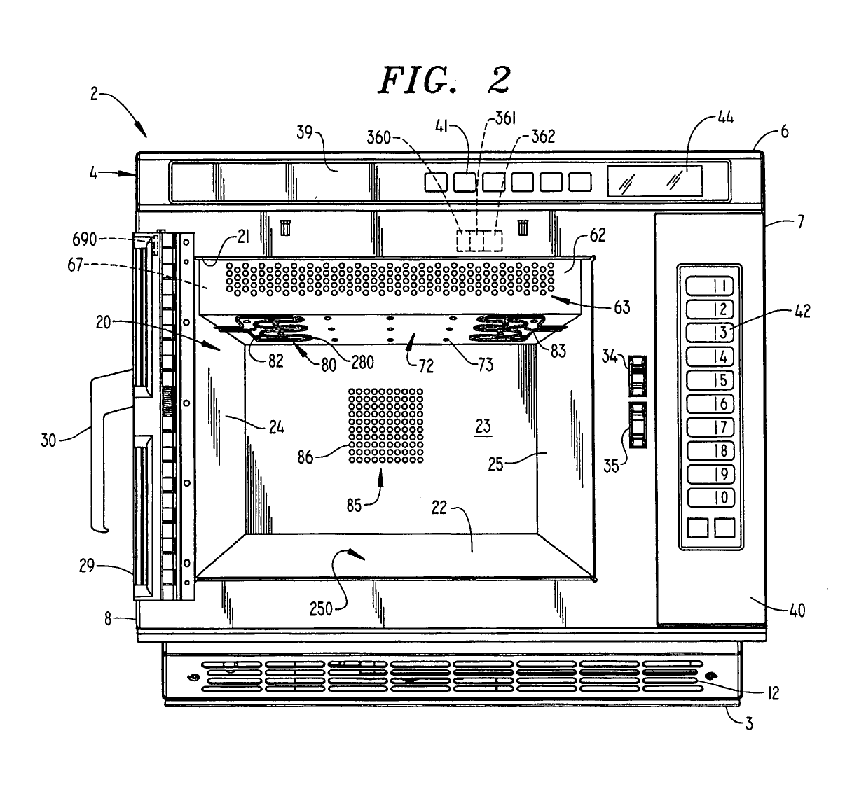

As best seen in FIG. 2, arranged within cabinet shell 4 is a cooking chamber 20 having top, bottom, rear and opposing side walls 21-25. In a manner known in the art, a door 29 is pivotally mounted to front wall 9 to selectively enable access to cooking chamber 20. Toward that end, door 29 includes a handle 30 and a window 31 for viewing the contents of cooking chamber 20 during a cooking operation. Although not shown, window 31 includes a screen (not shown) that prevents microwave energy fields from escaping from within cooking chamber 20 during a cooking operation. Handle 30 is adapted to interconnect to upper and lower latching mechanisms 34 and 35 so as to retain door 29 in a closed position and prevent operation of cooking appliance 2 whenever door 29 is opened.

Cooking appliance 2 is shown to include upper and side control panels 39 and 40, each of which includes a respective set of control buttons or elements 41 and 42. The sets of control elements 41 and 42, in combination with a digital display 44, enable a user to establish particular cooking operations for cooking appliance 2. For instance, control elements 41 can be used to establish the heating parameters of cooking appliance 2, while control elements 42 enable stored cooking times and/or operations to be readily selected. Since the general programming of cooking appliance 2 does not form part of the present invention, these features will not be described further herein.

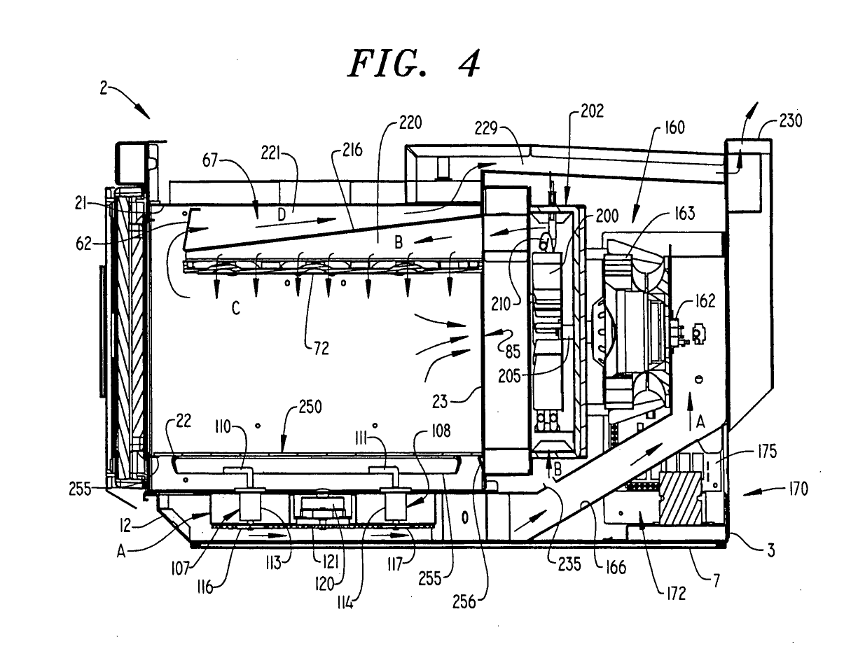

As further shown in FIG. 2, cooking appliance 2 includes a plenum cover 62 arranged at an upper portion of cooking chamber 20. As will be discussed more fully below, plenum cover 62 includes a plurality of openings, indicated generally at 63, that enable an exhaust air flow to pass from cooking chamber 20. Arranged behind plenum cover 62 is a bifurcated air plenum 67 (see FIG. 4) that provides air flow management for cooking chamber 20 during a cooking operation. More specifically, an air emitter plate 72 extends rearward from a lower portion of plenum cover 62 to rear wall 23 of cooking chamber 20. In accordance with a preferred embodiment of the invention, air emitter plate 72 includes a plurality of strategically placed openings 73 that are exposed to a lower portion of bifurcated plenum 67. A radiant heating device 80, including first and second radiant heating elements 82 and 83 (see FIG. 2), preferably extends along air emitter plate 72. More specifically, radiant heating elements 82 and 83 are constituted by sheathed, electric resistive elements, each having a serpentine-like pattern that extends fore-to-aft across a section of air emitter plate 72. In the most preferred embodiment, each heating element 82, 83 is capable of delivering 900 watts of energy into cooking chamber 20. More preferably, each heating element 82, 83 is configured to produce 60 watts/in² of power. Cooking appliance 2 also includes a convection air intake vent 85 having a plurality of convection air openings 86 positioned on rear wall 23 of cooking chamber 20.

As shown best with reference to FIGS. 3 and 4, cooking appliance 2 includes a microwave heating device 100 incorporating first and second magnetrons 102 and 103 ( see FIG. 3) that are adapted to generate and direct a combined microwave energy field into cooking chamber 20. As seen in FIG. 4, first and second magnetrons 102 and 103 include respective first and second rotating antenna assemblies 107 and 108. Each rotating antenna assembly 107, 108 includes an antenna portion 110, 111, a housing portion 113, 114 and a gear member 116, 117 respectively. In accordance with a preferred form of the invention, antenna assemblies 107 and 108 are arranged below bottom wall 22 of cooking chamber 20. In further accordance with the invention, antenna portions 110 and 111 are rotated so as to develop a uniform, constructive standing microwave energy field within cooking chamber 20. That is, antenna assemblies 107 and 108 are rotated by a drive motor 120 having a drive gear 121 which is drivingly connected to each of gears 116 and 117 of antenna assemblies 107 and 108, preferably through a gear train (not shown).

Referring to FIG. 3, magnetrons 102 and 103 are arranged in a microwave housing portion 131 of cooking appliance 2. Microwave housing portion 131 includes an angled divider 133 and a vertical divider 134. Although not shown, vertical divider 134 is formed with an opening leading beneath magnetron 102. In order to prevent magnetrons 102 and 103 from overheating, cooking appliance 2 is provided with a microwave cooling system 135 that includes a blower assembly 136 which is drivingly connected to a drive motor 138 positioned within a duct 139. Duct 139 extends from drive motor 138 to an opening 141 arranged below angled divider 133. With this arrangement, activation of cooking appliance 2 causes drive motor 138 to rotate, whereby blower assembly 136 establishes a cooling air flow. The cooling air flow is guided through opening 141 toward magnetron 103 due to the presence of angled divider 133. The cooling air flow circulates about magnetron 103, through vertical divider 134, across magnetron 102 and up along angled divider 133, in order to provide a cooling effect for magnetrons 102 and 103, before exiting cooking appliance 2 through vents 14.

In addition to microwave cooling system 135, cooking appliance 2 includes an air intake system 160 having an associated drive motor 162 coupled to an impeller 163. Drive motor 162 rotates impeller 163 so as to draw in an ambient air flow A through intake air vent 12. Intake air vent 12 leads to an intake air duct 166, while passing about drive motor 120 for antenna assemblies 107 and 108. A majority of the air flow A is circulated within a rear control housing portion 170 in order to cool a plurality of electronic components 172, including a main control board 175 which is adapted to receive input and/or programming instructions through control elements 41, 42 in order to establish and set various cooking operations for cooking appliance 2.

In addition to driving impeller 163, drive motor 162 operates a convection fan 200 positioned within a convection fan housing 202 that, in the embodiment shown, is arranged behind rear wall 23 of cooking chamber 20. More specifically, convection fan 200 is drivingly connected for concurrent rotation with impeller 163 through a drive shaft 205 such that operation of drive motor 162 is translated to convection fan 200 to establish a convective air flow B. Convective air flow B is passed over a convection air heating element 210 and delivered into cooking chamber 20 through openings 73 in air emitter plate 72. More specifically, as will be discussed further below, convective air flow B is directed into bifurcated air plenum 67 before passing into cooking chamber 20.

In further accordance with the preferred form of the invention, bifurcated air plenum 67 includes an angled divider plate 216 that defines a tapered air delivery portion 220 and a corresponding tapered exhaust portion 221. In the embodiment shown, air delivery portion 220 is essentially defined by air emitter plate 72, angled divider plate 216 and part of rear wall 23, while exhaust portion 221 is defined by plenum cover 62, top wall 21 and angled divider plate 216. In any event, air flow B developed through operation of convection fan 200 is heated by heating element 210, directed into air delivery portion 220 of bifurcated air plenum 67 and then lead into cooking chamber 20 through openings 73. The tapering of air delivery portion 220 is provided so that air initially entering bifurcated air plenum 67 from convection fan 200 passes through openings 73 in air emitter plate 72 with substantially the same pressure as air reaching an end portion (not separately labeled) of tapered air delivery portion 220.

As a portion of the cooking operation is constituted by convection heating, convective air flow B circulates about cooking chamber 20. This heated air flow has been found to particularly enhance the even cooking of a food item. As further represented in FIG. 4, a first portion of convective air flow B passes into convection air intake vent 85 through openings 86. The convective air flow B is heated/reheated by heating element 210 before being passed back into cooking chamber 20. At the same time, a second, preferably smaller portion of convective air flow B passes through openings 63 in plenum cover 62 and is directed out of cooking appliance 2. More specifically, plenum cover 62 leads into tapered exhaust portion 221. The exhaust air flow D entering into tapered exhaust portion 221 is passed upward into an exhaust duct 229 before exiting through an exhaust outlet 230 that, in the embodiment shown, is arranged at an upper rear portion of cooking appliance 2. To replace the lost air flow, convection fan 200 preferably draws or siphons a portion of air flow A. For this purpose, one or more openings 235 are provided in duct 166 in order to introduce fresh ambient air to the overall, circulating air flow. In this manner, certain cooking effluents, including moisture and steam, exit cooking chamber 20 through exhaust outlet 230, while a fresh supply of air is introduced into the remaining, recirculated air flow due to the presence of opening(s) 235.

In further accordance with the present invention, cooking appliance 2 includes a conductive heating device 250 that, in the most preferred form of the invention, defines bottom wall 22 of cooking chamber 20. Conductive heating device 250 is preferably constituted by a ceramic stone plate adapted to support food items within cooking chamber 20. Conductive heating device 250 advantageously provides a thermal conduction path for heating and browning of a food item. More specifically, upon activation of cooking appliance 2, radiant heat produced by heating elements 82 and 83 combines with convective air flow B generated by convection fan 200 to heat conduction heating device 250. Conductive heating device 250 is transparent to microwave energy so that microwave energy fields emitted by magnetrons 102 and 103 pass upward into cooking chamber 20 and further contribute to the overall cooking operation. In further accordance with the invention, conductive heating device 250 is supported upon a plurality of support brackets, such as those indicated at 255 and 256, to enable or facilitate removal of conductive heating device 250 for cleaning or other purposes.

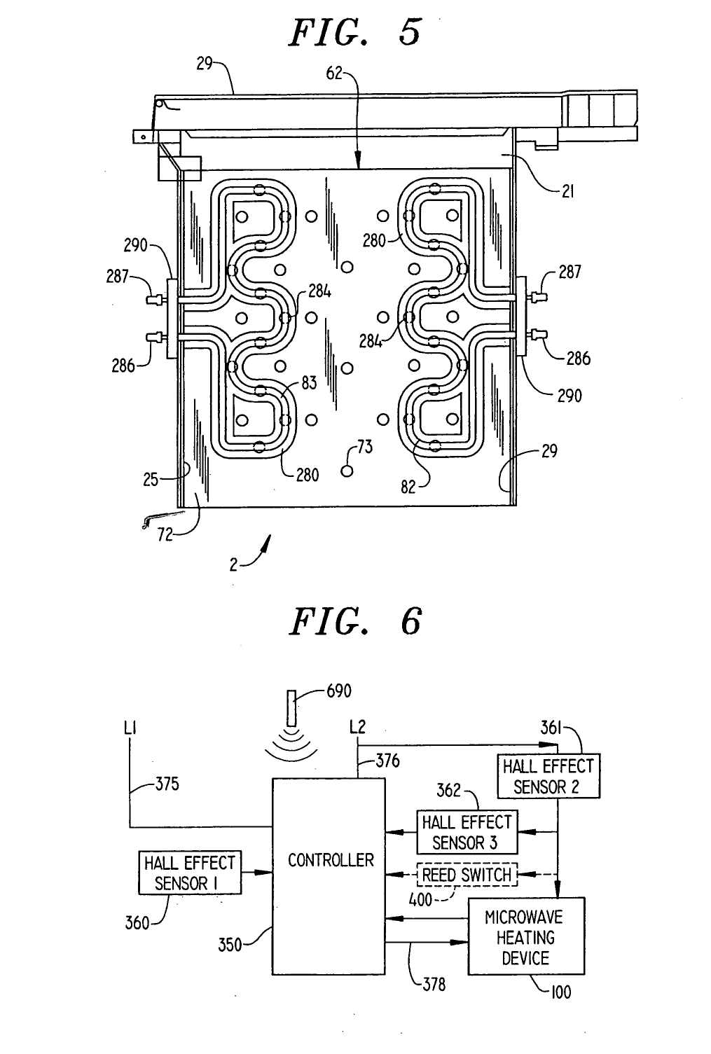

With particular reference to FIG. 5, air emitter plate 72 is preferably formed from anodized cast aluminum and provided with a pair of fore-to-aft extending recessed channels 280. Recessed channels 280 are provided with a plurality of openings 284. Heating elements 82 and 83 are nested within recessed channels 280 adjacent openings 284. As shown, each heating element 82, 83 includes a pair of electrodes 286 and 287 spaced from side walls 24 and 25 by an insulator 290. With this mounting arrangement, not only do heating elements 82 and 83 provide a source of radiant heat, but convective air flow B passing through openings 284 is heated by the additional thermal energy generated by heating elements 82 and 83 as air flow B passes from air delivery portion 210 of air plenum 67 into cooking chamber 20. Therefore, by being routed between, across and around respective ones of the various strategically placed openings 284, heating elements 82 and 83 evenly distribute thermal and infrared energy to the food being cooked.

With this overall combined cooking arrangement, a food item, for example, an open-faced sandwich placed within cooking chamber 20, can be exposed to a four-way combination cooking operation, i.e. radiant, microwave, convection and conductive heating techniques. The combination of the aforementioned heating techniques serves to cook the food item in an expeditious manner, while maintaining the required food quality. In addition, combining the aforementioned heating techniques enables cooking appliance 2 to be readily adapted to cook a wide range of food items in an efficient and effective manner, while also establishing an overall compact unit.

The above description of the preferred construction of cooking appliance 2 is provided for the sake of completeness and is covered by U.S. patent application entitled “Cooking Appliance including Combination Heating System” filed on even date herewith and incorporated by reference. The present invention is particularly directed to a sensing system for determining an open/closed position for door 29 and preventing operation of microwave heating device 100 when it is determined that door 29 is open. To this end, reference is made to FIG. 6 which schematically depicts a control unit 350, including a control board, which is electrically connected to a plurality of door position sensors 360-362. In general, when sensors 360 and 361 sense that door 29 is open, power is not sent to microwave heating device 100. As will be detailed more fully below, both sensors 360 and 361 must indicate that door 29 is closed in order for microwave heating unit 100 to be activated, while sensor 362 is actually part of a monitoring circuit or unit employed for protection purposes.

As schematically depicted in FIG. 6, control unit 350 is connected to hot leads 375 and 376 of an AC power source, with the power for operation of control unit 350 coming from lead 375. Control unit 350 is linked to microwave heating device 100 in a manner known in the art and functions to activate microwave heating device 100 through control line 378 as required for a desired cooking operation. However, sensor 360 is effectively interposed between control unit 350 and microwave heating device 100. That is, sensor 360 controls the completion of a circuit for the flow of power from control unit 350 to microwave heating device 100. If door 29 is open, sensor 360 does not complete the circuit and control unit 350 cannot supply power to microwave hearing device 100. On the other hand, sensor 361 operates between lead 376 and microwave heating device 100. With this arrangement, even if sensor 360 senses that door 29 is closed and therefore enables control unit 350 to power microwave heating device 100 through control line 378, sensor 362 can prevent any power from being sent to microwave heating device 100. That is, control unit 350 could be powered and sending signals to activate microwave heating device 100, but microwave heating device 100 cannot be activated without sensor 361 enabling power to be sent to microwave heating device 100. Finally, sensor 362 functions to make or break a circuit with microwave heating device 100 by potentially creating a short. That is, sensor 362 functions to complete a short circuit across microwave heating device 100 if it is sensed that door 29 is open.

In accordance with the preferred embodiment of the invention, sensors 360-362 are constituted by hall effect sensors. Although the particular circuitry employed in connection with hall effect sensors 360-362 could vary, the sensing arrangement employs a permanent magnet 690 fixed to door 29 as illustrated in FIG. 2, while the remainder of the structure shown in FIG. 6 is carried by cabinet shell 4. In any case, when door 29 is closed, each of sensors 360-362 has a closed loop back to control unit 350, wherein control unit 350 enables microwave device 100 to be activated based on input from a user. However, if door 29 is open, sensors 360-362 will not provide the requisite signals and the closed loops will be broken, whereupon microwave heating device 100 will be prevented from generating microwave energy.

In accordance with the invention, a fault with any one of sensors 360-362 will actually prevent the generation of microwave energy. More specifically, with the absence of a correct magnetic field impinging on sensor 360, no power is provided for regulating the operation of microwave heating device 100. When the correct magnetic field from permanent magnet 690 does not appropriately impinge on sensor 361, the power supply to microwave heating device 100 is directly cut-off in the manner set forth above. At the same time, sensor 362 establishes a level of protection by further monitoring the position of door 29 and shorting the power circuit across microwave heating device 100 if door 29 is open. Therefore, if any one of sensors 360, 361 or 362 fails to sense the closure of door 29, no microwave energy can be generated.

As indicated, the preferred embodiment of the invention discussed above has each of sensors 360-362 being defined by a hall effect sensor. In accordance with another embodiment of the invention, hall effect sensor 362 is replaced by a reed switch 400. As the remaining structure and functions have direct correspondence to that discussed above, a detailed discussion of this embodiment will not be reiterated here. However, in accordance with this embodiment, reed switch 400 is preferably, normally closed with the closure of door 29. In any case, reed switch 400 provides an added level of protection in the overall control of microwave heating device 100.

Although described with reference to preferred embodiments of the present invention, it should be readily apparent to one of ordinary skill in the art that various changes and/or modifications can be made to the invention without departing from the spirit thereof. In general, it is only important that a permanent magnet be fastened to the door and cooperate with a sensing circuit arranged in a cabinet of the cooking appliance, with the sensing circuit preferably employing three sensing units which individually sense the open/closed position of the door and separately control the potential operation of the microwave heating device, either directly or indirectly. Particularly, hall effect sensors, with or without a reed switch which can actually replace any of the hall effect sensors, are used to detect the magnetic field of the permanent magnet. The delivery of power supplies is terminated in the absence a predetermined magnetic field impinging on two of the sensing units, with the third sensing unit actually being part of a solid-state monitor circuit provided for protection purposes by shorting a power supply circuit. In any case, the invention is only intended to be limited to the scope of the following claims.

1. A cooking appliance comprising:
a cabinet including top, bottom rear and opposing side walls;
a cooking chamber including top, bottom, rear and opposing side walls and a frontal opening;
a door movably mounted relative to the cooking chamber between an open position for accessing the cooking chamber and a closed position closing the frontal opening;
a microwave heating device arranged to deliver a microwave energy field into the cooking chamber;
a door position sensing system including:
a permanent magnet affixed for movement with the door between the open and closed positions, said permanent magnet generating a magnetic field; and
first and second sensors fixed relative to the cabinet and responsive to the magnetic field for producing signals depending upon whether the door is in the open or closed position; and
control means for operating the microwave heating device, said first sensors regulating an ability of the control means to operate the microwave heating device and the second controlling power delivered to the microwave heating device.

2. The cooking appliance according to claim 1, wherein the door position sensing system further includes a third sensor, said third sensor also controlling power delivered to the microwave heating device.

3. The cooking appliance according to claim 2, wherein the second sensor directly creates a power circuit to the microwave heating device when the door is closed.

4. The cooking appliance according to claim 3, wherein the third sensor creates a short in the power circuit to the microwave heating device when the door is open.

5. The cooking appliance according to claim 2, wherein each of the first, second and third sensors constitutes a hall effect sensor.

6. The cooking appliance according to claim 2, wherein the first and second sensors are constituted by hall effect sensors and the third sensor is constituted by a reed switch.

7. The cooking appliance according to claim 2, wherein the third sensor is in parallel with the microwave heating device.

8. The cooking appliance according to claim 7, wherein the third sensor is in series with the second sensor.

9. A method of performing a cooking operation in a microwave cooking appliance comprising:
placing a food item into a cooking chamber of the cooking appliance;
generating a microwave energy field;
directing the microwave energy field into the cooking chamber;
sensing if a predetermined magnetic field, developed by a permanent magnet affixed to the door, impinges upon two separate sensors fixed relative to a cabinet of the cooking appliance; and
terminating the generation of the microwave energy field when the door is determined to be in the open state based on an absence of the predetermined magnetic field impinging upon either one of the two separate sensors.

10. The method of claim 9, further comprising:
sensing whether the door is in an open or closed state through a third sensor; and
preventing the generation of microwave energy when the third sensor senses that the door is open.

11. The method of claim 10, further comprising:
controlling power delivered from a control unit to the microwave heating device based on signals from the first sensor; and
creating a power circuit to the microwave heating device through the second sensor when the door is closed.

12. The method of claim 11, further comprising: creating a short in the power circuit to the microwave heating device through the third sensor when the door is open.
